(19) United States
(12) Patent Application Publication
(10) Pub. No.: US 2015/0161635 A1
(43) Pub. Date: Jun. 11, 2015

(54) DYNAMIC PRICE ELASTICITY IN UNSTRUCTURED MARKETPLACE DATA

(71) Applicant: eBay Inc., San Jose, CA (US)

(72) Inventors: Ted Tao Yuan, Cupertino, CA (US); Zhaohui Chen, Saratoga, CA (US); Daniel Fain, Saratoga, CA (US)

(73) Assignee: EBAY INC., SAN JOSE, CA (US)

(21) Appl. No.: 14/101,491

(22) Filed: Dec. 10, 2013

(51) Int. Cl. G06Q 30/02

(52) U.S. Cl. CPC G06Q 30/0206

(57) ABSTRACT

In an example embodiment, a pseudo product group for an item to be listed in an online marketplace having unstructured data is determined. Then, a fair market price for the item is determined using past data from listings in the pseudo product group. The fair market price may be used as a reference price in a curve of price elasticity versus price to obtain a price elasticity value. A price range may then be recommended to a user for the listing based upon the fair market price and the price elasticity value.

### TECHNICAL FIELD

This application relates generally to unstructured marketplace data. More specifically, this application relates to enhancing price suggestion to sellers and evaluating the revenue impact of large scale unstructured marketplace data with dynamic price elasticity.

### BACKGROUND

Online web applications typically use conversion rate to evaluate overall system performance. Specifically, click through rate (CTR) is a common target for web search ranking systems, and sale conversion rate (sale per impression) is a target to measure the performance of an e-commerce marketplace. Generally, when the price of an item is increased, its sales volume will go down, and vice-versa. In unstructured marketplaces, such as marketplaces where rare, unique, and/or unusual items are sold, or where sellers may not be selling multiple quantities of the same item, the outcome of price changes can be difficult to predict.

### BRIEF DESCRIPTION OF DRAWINGS

FIG. 1 is a network diagram depicting a client-server system, within which one example embodiment may be deployed.

FIG. 2 is a block diagram illustrating multiple applications and that, in one example embodiment, are provided as part of the networked system.

FIG. 3 is a graph illustrating an example of data sampled from a particular listing category, in accordance with an example embodiment.

FIG. 4 is a graph illustrating an example of corresponding price elasticity at each price point.

FIG. 5 is a diagram illustrating the data driven process, in accordance with an example embodiment.

FIGS. 6A and 6B are graphs showing demand curves from other product categories, in accordance with an example embodiment.

FIGS. 7A and 7B are graphs showing corresponding price elasticity curves, in accordance with an example embodiment.

FIG. 8 is a flow diagram illustrating a method of listing an item in an online marketplace, in accordance with an example embodiment.

FIG. 9 is a flow diagram illustrating a method of establishing a search ranking algorithm, in accordance with an example embodiment.

FIG. 10 is a block diagram illustrating a mobile device 1000, according to an example embodiment.

FIG. 11 is a block diagram of a machine, in the form of a computer system, within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. However, it will be evident to those skilled in the art that embodiments of the inventive subject matter may be practiced without these specific details. In general, well-known instruction instances, protocols, structures, and techniques have not been shown in detail.

In an example embodiment, the concept of price elasticity is extended to a large-scale online marketplace environment, where unbranded or unstructured listings are for sale. In such cases, the demand history for individual items or listings may not exist. In an example embodiment, items are grouped into inferred pseudo products. An inferred pseudo product is a group of items that are similar according to some established criteria. An inferred pseudo product may comprise one or two main types of goods, and a mix of substitute and complementary items.

A data-driven method may be used to generate dynamic price elasticity in near real time. This dynamic price elasticity information can be used in a number of ways in the online marketplace, including monitoring market demand and inventory health in near real-time, helping sellers to price a listing accurately, and ranking items for search results.

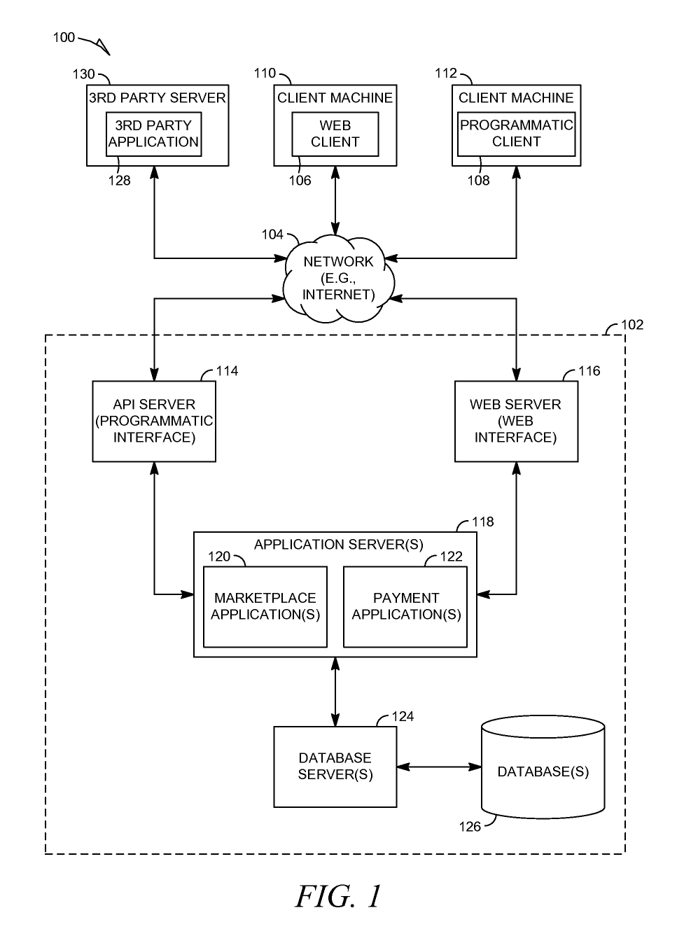

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)), to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the client-server system 100 shown in FIG. 1 employs a client-server architecture, the embodiments are not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

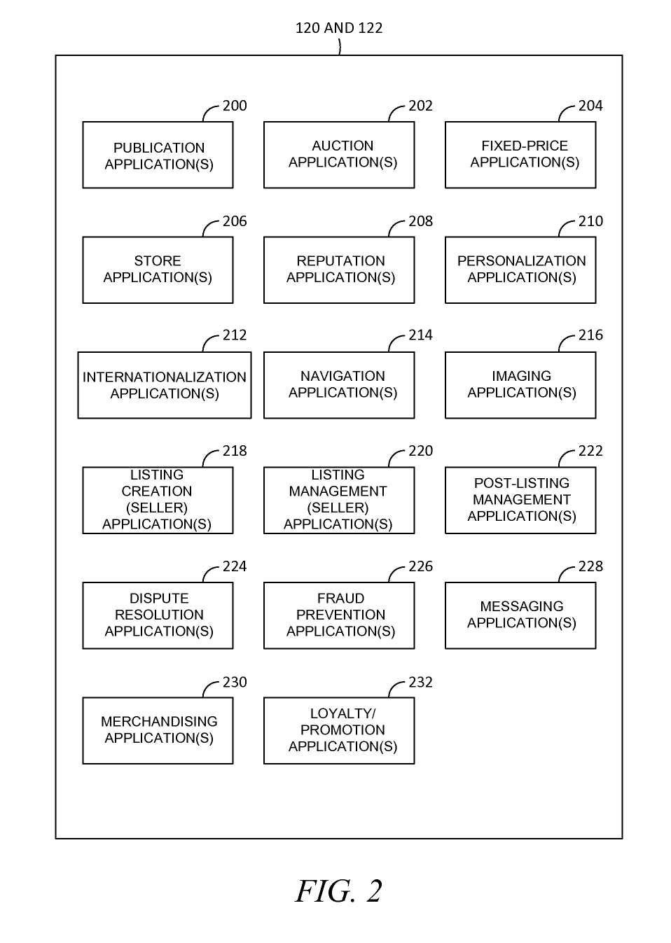

FIG. 2 is a block diagram illustrating marketplace and payment applications 120 and 122 that, in one example embodiment, are provided as part of the networked system 102. The marketplace and payment applications 120 and 122 may be hosted on dedicated or shared server machines (not shown) that are communicatively coupled to enable communications between server machines. The marketplace and payment applications 120 and 122 themselves are communicatively coupled (e.g., via appropriate interfaces) to each other and to various data sources so as to allow information to be passed between the marketplace and payment applications 120 and 122, or so as to allow the marketplace and payment applications 120 and 122 to share and access common data. The marketplace and payment applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. For example, consider that where the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the marketplace and payment applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208 so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 such as, for example, messages advising users regarding the status of listings at the networked system 102 (e.g., providing “outbid” notices to bidders during an auction process or to provide promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, Wi-Fi, Wi-MAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and may be offered a reward for which accumulated loyalty points can be redeemed.

In an example embodiment, one of the marketplace applications 120 may calculate price elasticity in order to derive approximated total revenue and/or make price suggestions to sellers.

For a large-scale, diversified online marketplace, total revenue can be approximated according to the following formula (ignoring incidental fees, such as insertion, sales, and shipping and handling fees):

Revenue(R)=Average Sales Price*Quantity Sold

In the case of a product catalog system, where all items are classified to brands or well-known products, this can be further broken down into the sum of revenue of all products or product categories (pc), specifically:

R==Σpc=Σ(Average Sales Price_{PC}*Quantity Sold_{PC})

To generalize, for a marketplace comprising large volume and diversified items, with or without product classification (unstructured data),

R=Σi(SalePriceᵢ*QuantitySoldᵢ)=Σv(Average Sales Priceᵥ*Quantity Soldᵥ)

where i represents individual items (listings) and v is a hidden/latent classification variable.

The latent or application-specific variable v groups all listings into mutually exclusive buckets (pseudo products). In unstructured systems, individual listings can be temporary and without known sales history. Listing segmentation provides a persistent view of similar items in order to track sale behaviors and metrics. Examples of groups can be by sale type (auction/fixed price), inferred listing category, similar listing cluster, seller, etc.

If revenue R=Price*Quantity of demand, the total revenue change at a price point p is,

$$\begin{matrix}dR = {\sum }_{v} dR\_v \\ = {\sum }_{v} ( dP\_v * Q\_v + P\_v * dQ\_v ) \\ = {\sum }_{v} ( 1 + e\_v ) * Q\_v * dP\_v\end{matrix}$$

where e_v is the price elasticity of demand at price p for group v of the unstructured data, which is defined as

e_{—}v=dQ_{—}v/Q_{—}v*P_{—}v/dP_{—}v.

The relative revenue change is

$$\begin{matrix}dR / R = {\sum }_{v} ( 1 + e\_v ) * P\_v * Q\_v / R * dP\_v / P\_v \\ = {\sum }_{v} ( 1 + e\_v ) * W\_v * dP\_v / P\_v ,\end{matrix}$$

where W_v=R_v/R with R_v=P_v*Q_v, W_v is the revenue weight of the bucket by variable v.

As stated before, conventional price elasticity is not readily applicable to marketplaces with unclassified/non-product goods (unstructured data), as the items do not have individual sales history. The price elasticity defined herein is therefore different than the conventional price elasticity, which is typically defined for a brand, product or well-known same product conglomerate with stable and long sales history. While both price elasticities have the same form, the present definition is based on any suitable mutually exclusive listing classification grouping in a market place. It may be called dynamic price elasticity, but the term price elasticity may be used liberally in this document according to the new definition.

Since grouping of the unstructured inventory is not all mapped to well-known products, e_v is not usually monolithic with respect to price, but varies significantly as marketplace condition/inventory changes; therefore, it is a function of time.

TABLE 1

| Group | v1 | v2 | v3 | . . . | Vn |
|---|---|---|---|---|---|
| Price | e1(p, t) | e2(p, t) | e3(p, t) | . . . | en(p, t) |
| Elasticity | | | | | |
| e_v | | | | | |

Knowing the price elasticity e_v of all groups or sub-segments of a marketplace allows finer tuning and study of revenue change by price variation via latent variable classification. For a certain inventory segment v, given a price target with everything else equal (e.g., same relevance constraint), if e_v is found to be >=0 (perfectly inelastic), it suggests that incrementally higher price items should be attempted to be presented in the pseudo product group v to buyers; if −1<e_v<0 (not elastic), then higher priced listings in a pseudo product group should be selected as top candidates in response to a buyer query; and if e_v<−1 (elastic), then buyers are generally looking for cheaper deals, and price increment would result in a larger proportion of sales drop or revenue loss.

Thus, revenue impact of a hypothetical cross-board or local price increment can be calculated if each market segment's price elasticity e_v and revenue weight W_v in targeted price range is known.

While the price elasticity for a particular known type of merchandise can be constant or fitted into a model that may be stable for a long period of time, it is conceivable that an observed demand curve for a group of mildly similar items can be complex and time varying, hence its price elasticity as defined above. This reflects a diverse relationship between sales and price variation of similar underlying, but different merchandises.

For example, if online merchandise listings are grouped into inferred listing categories, then each category loosely holds a collection of similar goods (e.g., branded products in various conditions, old unbranded collectibles and related cheap new accessories, etc).

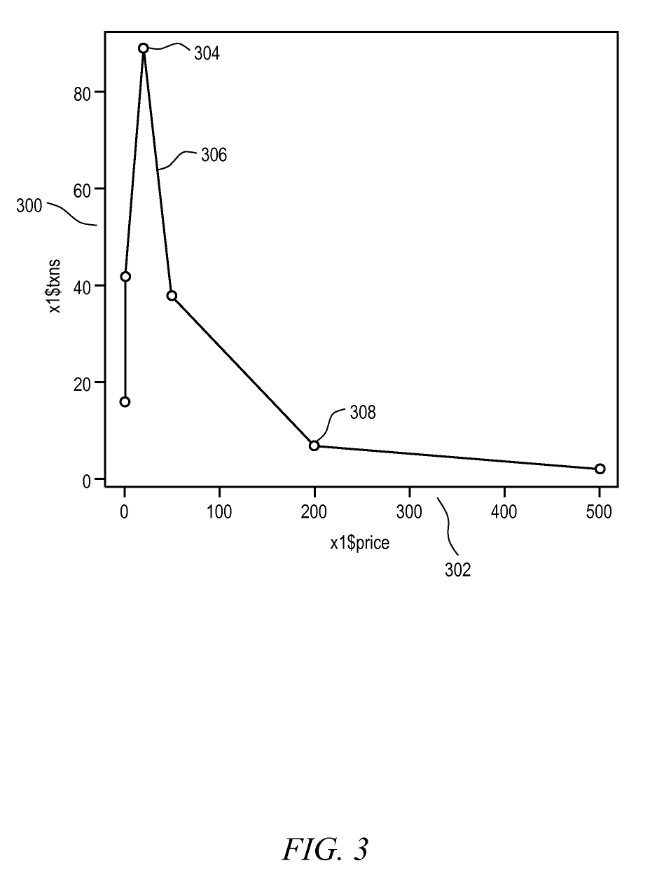

FIG. 3 is a graph illustrating an example of data sampled from a particular listing category, specifically a category covering various collectible and historical advertisement artifacts of a well-known oil and gas company, in accordance with an example embodiment. For the observed demand 300 in the category, strong demand is seen at the lower end of price 302 up to about $20 (at reference 304), sales then sharply decrease around $20 (at reference 306), and ultimately level off on the long tail after $200 (at reference 308). The price elasticity of demand at each price point can be computed based on fitted function of the sample points.

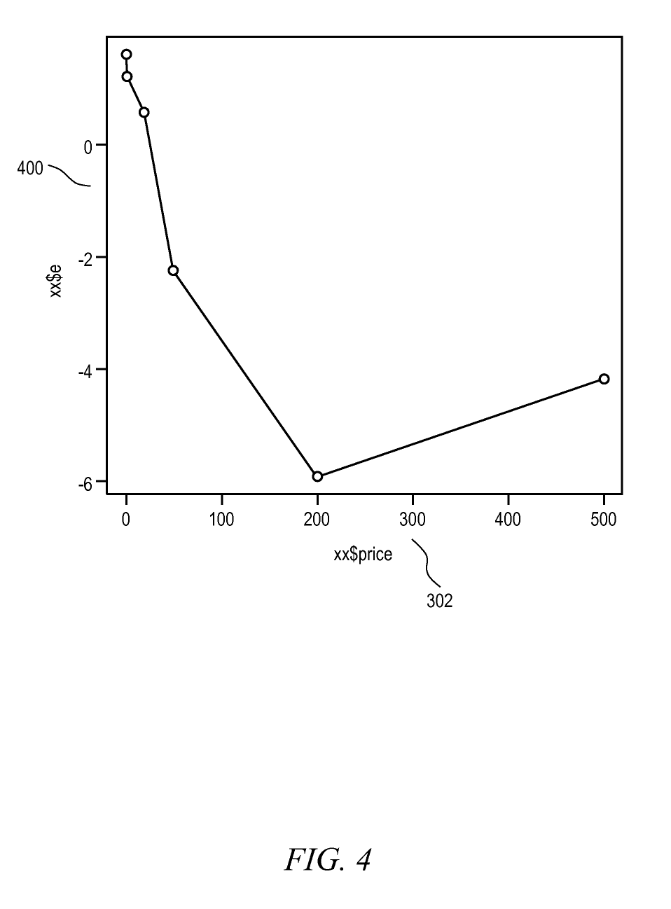

FIG. 4 is a graph illustrating an example of corresponding price elasticity 400 at each price point 402.

It is also observed that the demand curve and, hence, price elasticity changes from time to time when online inventory changes. Price elasticity can be updated by frequently sampling the sale history. This allows price elasticity to be measured and utilized in real-time.

In an example embodiment, a data driven system can be provided that automatically updates price elasticity by sampling the demand curve for every listing inventory classification bucket. An automated computer program may be used to sample demand and generate price elasticity according to the formula as illustrated above. The data driven system can effectively provide almost real time metrics and discovery for an online marketplace having mostly unstructured listings, which helps in estimating revenue change with dynamic demands from similar listing groups or pseudo product classifications.

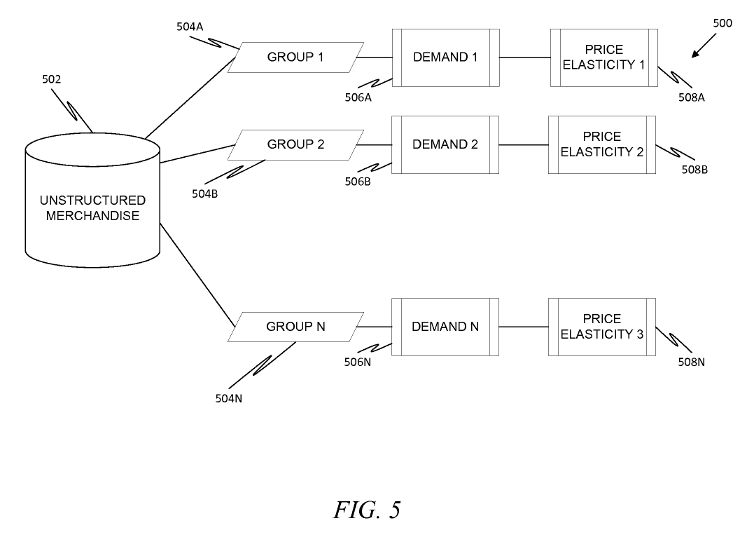

FIG. 5 is a diagram illustrating the data driven process, in accordance with an example embodiment. The data driven process 500 has the following steps: 1) classify unstructured data 502 into mutually exclusive groups 504A-504N, 2) generate demand by price curves 506A-506N from recent sales history, 3) generate price elasticity curves 508A-508N. Steps 2 and 3 can be automated and are repeatable. Other examples will now be provided.

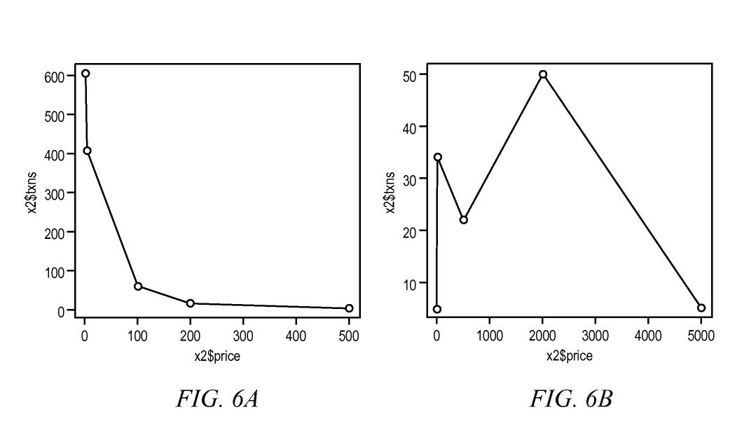

FIGS. 6A and 6B are graphs showing demand curves from other product categories (here related to collectible coins), in accordance with an example embodiment. FIG. 6A indicates a relatively predictable pseudo product grouping. FIG. 6B indicates diversity (non-perfect classification) in the listing group, as evidenced by its more irregular curve.

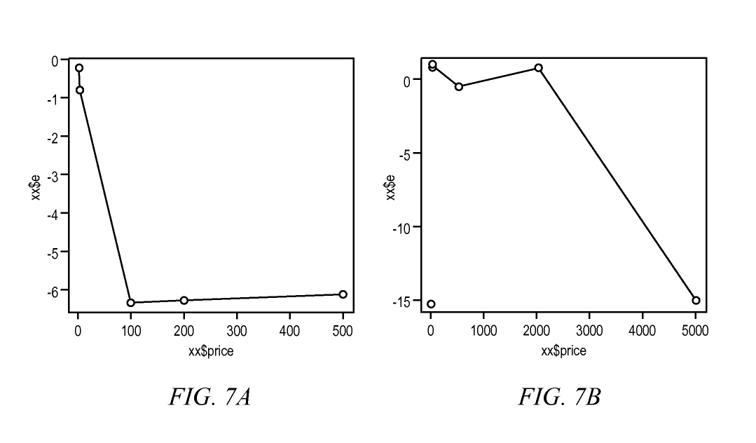

FIGS. 7A and 7B are graphs showing corresponding price elasticity curves, in accordance with an example embodiment.

As previously described, there are a number of applications for price elasticity for the unstructured data model. Example applications will be described herein; however, one of ordinary skill in the art will recognize that these are only examples and are not intended to be limiting.

In a first example, a seller pricing tool can be provided. The selling tool may include a number of fields for the seller to fill out when listing an item, such as title, description, shipping information, etc. In recent years, such selling tools have been made easier through the automatic or semiautomatic population of fields. For example, a user may be able to scan a bar code with a mobile device running the selling pricing tool and, subsequently, the selling pricing tool may automatically complete a number of the fields (title, description, etc.) by looking up the bar code in a database. In an example embodiment, the movement towards this type of automation may be extended by suggesting prices, or ranges of prices, at which the user should sell the item. These price suggestions may be based on a number of factors, but in the example embodiment, one of the factors would include price elasticity information as determined by the above model. Thus, the selling tool recommends selling prices based on the values of price elasticity of demand in the pseudo product grouping, including the item to be listed. When demand matches supply, an equilibrium state in the pseudo product grouping is reached which may be reflected as a certain price elasticity value of the market segment around a given target price. Price deviation from the equilibrium market price value would result in fewer sales for an elastic demand. The equilibrium may be observed at or near a price corresponding to unit elasticity (price elasticity value equal to −1) and at maximum revenue.

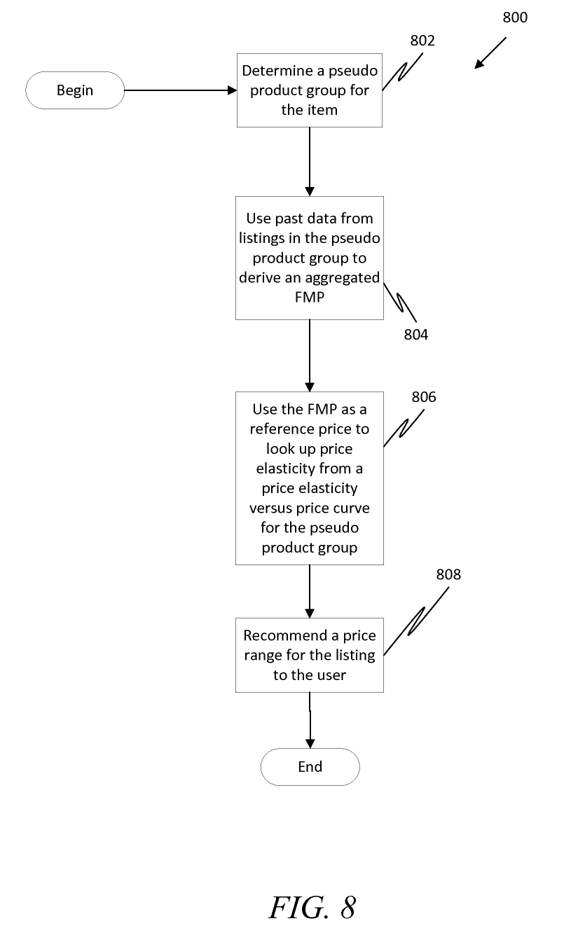

FIG. 8 is a flow diagram illustrating a method 800 of listing an item in an online marketplace, in accordance with an example embodiment. At 802, a pseudo product group for the item may be determined. At 804, past data from listings in the pseudo product group may be used to derive an aggregated fair market price (FMP). This past data can include listings on similar items within the pseudo product group, including previous sales and previous listings (even if unsold). At 806, the aggregated fair market price is used as a reference price to look up price elasticity from a price elasticity versus price curve that is specific to the pseudo product group. At 808, a recommended price range for the listing may be made to the user. This recommended price is a function of variables including aggregated fair market price, sale type, price elasticity value at the aggregated fair market value price, price when it is unit elastic demand, etc. For example, for an auction listing type, a recommended auction starting price range may be between 0 and a minimum of the aggregated fair market price and the price when it is in unit elastic demand. In the fixed-price scenario, the reasonable starting price suggestion may be around the aggregated fair market value price, equal or lower if price elasticity is less than −1 and higher if the price elasticity is greater than 0.

In online marketplaces, there are also many sellers selling small electronic accessories such as tablet cases, screen protectors, earphones, power adapters, etc. Many sellers believe that offering lower prices than their competitors is the best way of ensuring higher revenue. However, the price elasticity curve may turn out to be positive (inelastic demand) and, thus, a small price increase may not dampen sales. In such cases, the system would recommend prices that wouldn't cause the seller to unnecessarily lower the sale prices of items, but would focus the seller on other factors, such as creating better images, clearer descriptions, allowing a return policy, providing free and express shipping, etc.

In a second example, a ranking of listings may be modified in consideration of the total revenue impact. Query result ranking on a user search results page has significant impact on the sales and revenue of an online marketplace. Listings placed in the top positions of a search results page normally attract more attention from buyers and have a better chance of selling. Items located on a second page of a search results query have significantly lower viewership than items located on a first page of the search results.

Search results ranking algorithms for online marketplaces typically use click-through-rate or sale-per-impression as a large factor. This winds up favoring cheaper items that might actually diminish the revenue target of the whole marketplace. With the help of data driven and dynamic price elasticity information from all possible market inventory segments, an example embodiment can correct the click-through-rate and sale-per-impression low-price bias.

In the development of the ranking algorithm, the revenue impact can be computed using dynamic price elasticity for the price change in each market segment that is due to the proposed new ranking change. The dynamic price elasticity, as well as the computed/measured price delta due to the change of the new ranking factor in each market segment, can provide the knowledge that links the ranking factor change to the positive or negative impact of the total revenue of the marketplace.

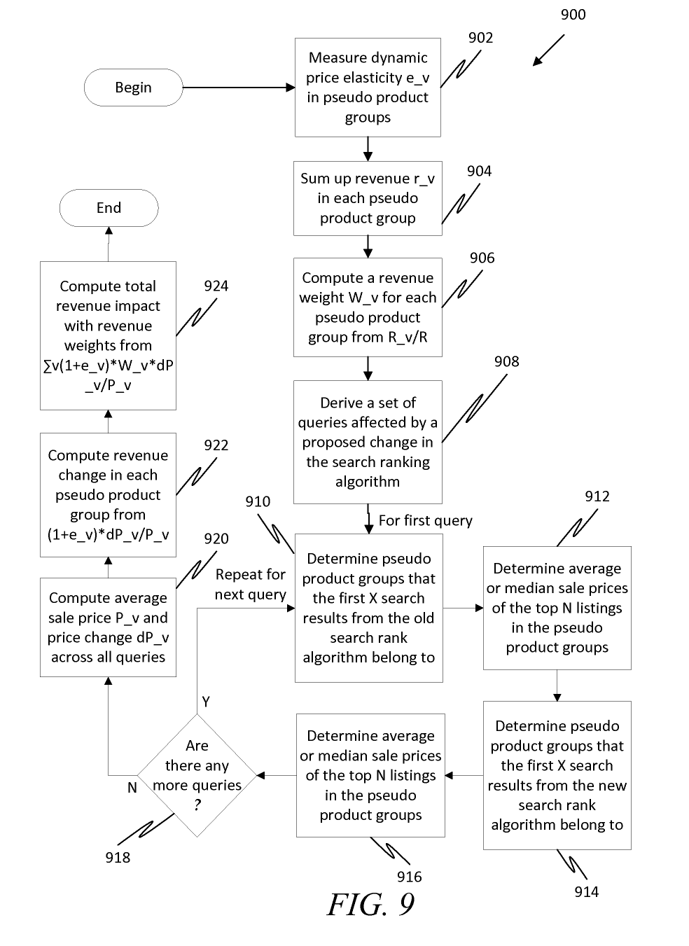

FIG. 9 is a flow diagram illustrating a method 900 of establishing a search ranking algorithm, in accordance with an example embodiment. At 902, dynamic price elasticity e_v may be measured in pseudo product groups. At 904, revenue r_v in each pseudo product group can be summed up. At 906, a revenue weight W_v for each pseudo product group can be computed from R_v/R, where R is the total revenue in the system.

At 908, a set of queries affected by a proposed change in the search ranking algorithm from an old search ranking algorithm to a new search ranking algorithm may be derived. A loop may then begin. For each query, at 910, the pseudo product groups that the first X search results from the old search ranking algorithm belong to are determined. At 912, the average or median sale prices of the top N listings in each of these pseudo product groups from the old search ranking algorithm may be determined. At 914, the pseudo product groups that the first X search results from the new ranking algorithm belong to are determined. At 916, the average or median sale prices of the top N listings in each of these pseudo product groups from the new search ranking algorithm may be determined.

At 918, it may be determined if there are any more queries. If so, the process loops back to 910. If not, the process continues to 920, where the average sale price P_v and price change from old search ranking algorithm to new search ranking algorithm dP_v, across all queries, are computed. At 922, the revenue change in each pseudo product group is computed from (1+e_v)*dP_v/P_v.

At 924, the total revenue impact is computed with the revenue weights from

Σv(1+e_{—}v)*W_{—}v*dP_{—}v/P_{—}v.

### Example Mobile Device

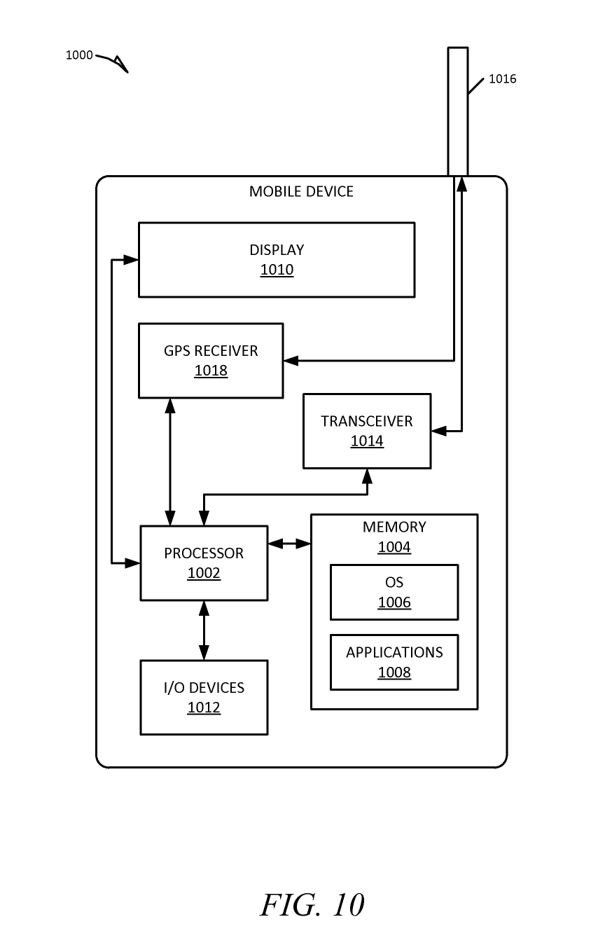

FIG. 10 is a block diagram illustrating a mobile device 1000, according to an example embodiment. The mobile device 1000 may include a processor 1002. The processor 1002 may be any of a variety of different types of commercially available processors suitable for mobile devices (for example, an XScale architecture microprocessor, a microprocessor without interlocked pipeline stages (MIPS) architecture processor, or another type of processor 1002). A memory 1004, such as a random access memory (RAM), a flash memory, or other type of memory, is typically accessible to the processor 1002. The memory 1004 may be adapted to store an operating system (OS) 1006, as well as application programs 1008, such as a mobile location enabled application that may provide LBSs to a user. The processor 1002 may be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 may be coupled to a transceiver 1014 that interfaces with an antenna 1016. The transceiver 1014 may be configured to both transmit and receive cellular network signals, wireless data signals, or other types of signals via the antenna 1016, depending on the nature of the mobile device 1000. Further, in some configurations, a GPS receiver 1018 may also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors 1002 may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software), may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respectively different hardware-implemented modules at different times. Software may, accordingly, configure the processor 1002, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors 1002 that are temporarily configured (e.g., by software) or permanently configured to perform the relevant operations. Whether temporarily or permanently configured, such processors 1002 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 1002 or processor-implemented modules. The performance of certain of the operations may be distributed among the one or more processors 1002, not only residing within a single machine, but deployed across a number of machines. In some example embodiments, the processor 1002 or processors 1002 may be located in a single location (e.g., within a home environment, an office environment or as a server farm), while in other embodiments, the processors 1002 may be distributed across a number of locations.

The one or more processors 1002 may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product (e.g., a computer program tangibly embodied in an information carrier, e.g., in a machine-readable medium for execution by, or to control the operation of, data processing apparatus, e.g., a programmable processor 1002, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors 1002 executing a computer program to perform functions by operating on input data and generating output. Method operations can also be performed by, and apparatus of example embodiments may be implemented as, special purpose logic circuitry (e.g., a field programmable gate array (FPGA) or an application-specific integrated circuit (ASIC)).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 1002), or a combination of permanently and temporarily configured hardware may be a design choice. Below, are set out hardware (e.g., machine) and software architectures that may be deployed in various example embodiments.

### Example Machine Architecture and Machine-Readable Medium

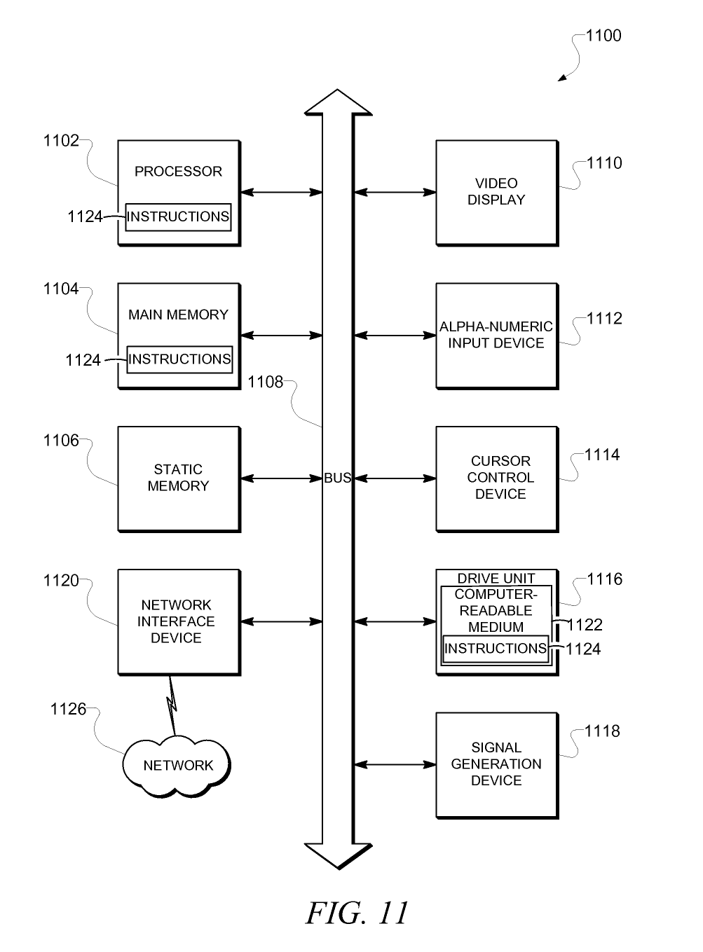

FIG. 11 is a block diagram of machine, in the example form of a computer system 1100, within which instructions 1124 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1124 (sequential or otherwise) that specify actions to be taken by that machine. Further, while only a single machine is illustrated, the term “machine” shall also be taken to include any collection of machines that, individually or jointly, execute a set (or multiple sets) of instructions 1124 to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation (e.g., cursor control) device 1114 (e.g., a mouse), a disk drive unit 1116, a signal generation device 1118 (e.g., a speaker) and a network interface device 1120.

### Machine-Readable Medium

The disk drive unit 1116 includes a computer-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting computer-readable media 1122.

While the computer-readable medium 1122 is shown in an example embodiment to be a single medium, the term “computer-readable medium” may include a single medium or multiple media (e.g., a centralized or distributed database, and/or associated caches and servers) that store the one or more instructions 1124 or data structures. The term “computer-readable medium” shall also be taken to include any tangible medium that is capable of storing, encoding or carrying instructions 1124 for execution by the machine, and that cause the machine to perform any one or more of the methodologies of the present disclosure or that is capable of storing, encoding or carrying data structures utilized by or associated with such instructions 1124. The term “computer-readable medium” shall accordingly be taken to include, but not be limited to, solid-state memories, and optical and magnetic media. Specific examples of computer-readable media 1122 include non-volatile memory, including by way of example, semiconductor memory devices (e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks 1126 include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1124 for execution by the machine, and includes digital or analog communications signals or other intangible media to facilitate communication of such software.

Although the inventive subject matter has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is, in fact, disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An apparatus comprising:
a memory; and
a seller tool executable by a processor and configured to:
determine a pseudo product group for an item to be listed in an online marketplace having unstructured data;
derive a fair market price for the item using past data from listings in the pseudo product group;
use the fair market price as a reference price in a curve of price elasticity versus price to obtain a price elasticity value; and
recommend a price range to a user for the listing based upon the fair market price and the price elasticity value.

2. The apparatus of claim 1, wherein the unstructured data is historical data that lacks demand information for the item.

3. The apparatus of claim 1, wherein the pseudo product group is one of a plurality of mutually exclusive product categories.

4. The apparatus of claim 1, wherein the user is a seller of the item to be listed.

5. A method comprising:
determining a pseudo product group for an item to be listed in an online marketplace having unstructured data;
deriving a fair market price for the item using past data from listings in the pseudo product group;
using the fair market price as a reference price in a curve of price elasticity versus price to obtain a price elasticity value; and
recommending a price range to a user for the listing based upon the fair market price and the price elasticity value.

6. The method of claim 5, wherein the price range is recommended to the user in a seller tool that is utilized when the user lists the item for sale in the online marketplace.

7. The method of claim 6, wherein the price range is presented to the user in the seller tool next to an input box where the user enters a price at which to sell the item.

8. The method of claim 5, wherein the unstructured data is historical data that lacks demand information for the item.

9. The method of claim 5, wherein the pseudo product group is one of a plurality of mutually exclusive product categories.

10. A non-transitory machine-readable storage medium having embodied thereon instructions executable by one or more machines to perform operations comprising:
determining a plurality of pseudo product groups in an online marketplace;
determining dynamic price elasticity in each of the pseudo product groups;
receiving a proposed change to a search ranking algorithm;
determining, based on the dynamic price elasticity in each pseudo product group affected by the proposed change to the search ranking algorithm, an estimated total revenue impact of the proposed change; and
determining whether or not to implement the proposed change based on the estimated total revenue impact.

11. The non-transitory machine-readable storage medium of claim 10, wherein the operations further comprise:
summing up revenue in each of the pseudo product groups;
computing a revenue weight for each pseudo product group from the revenue; and
deriving a set of queries affected by the proposed change in a search ranking algorithm.

12. The non-transitory machine-readable storage medium of claim 11, wherein the operations further comprise:
for each of the derived set of queries:
determining pseudo product groups that a first preset number of search results from an old search rank algorithm belong to;
determining average sale prices of the top preset number of listings in the determined pseudo product groups for the old search rank algorithm;
determining pseudo product groups that a first preset number of search results from a new search rank algorithm belong to; and
determining average sale prices of the top preset number of listings in the determined pseudo product groups for the new search rank algorithm.

13. The non-transitory machine-readable storage medium of claim 11, wherein the determining an estimated total revenue impact of the proposed change includes:
computing an average sale price and price change across all queries in the derived set of queries;
computing a revenue change in each pseudo product group from the average sale price and price change; and
computing a total revenue impact with revenue weights based on the revenue change.

14. The non-transitory machine-readable storage medium of claim 13, wherein the computing a revenue change uses the formula (1+e_v)*(dP_v/P_v), wherein e_v is a dynamic price elasticity, dP_v is the price change and P_v is the average sale price.

15. The non-transitory machine-readable storage medium of claim 13, wherein the computing a total revenue impact with revenue weights uses the formula Σv(1+e)*W_v*dP_v/P_v, wherein W_v is the revenue weight for each pseudo product group.

16. The non-transitory machine-readable storage medium of claim 10, wherein the dynamic price elasticity is determined by deriving a fair market price for an item using past data from listings in a pseudo product group and using the fair market price as a reference price in a curve of price elasticity versus price to obtain a price elasticity value.

17. The non-transitory machine-readable storage medium of claim 16, wherein the dynamic price elasticity is determined using unstructured data.

18. The non-transitory machine-readable storage medium of claim 17, wherein the unstructured data is historical data that lacks demand information for an item.

19. The non-transitory machine-readable storage medium of claim 10, wherein the pseudo product groups are a plurality of mutually exclusive product categories.

20. The non-transitory machine-readable storage medium of claim 10, wherein estimated total revenue impact is an estimate of effect on the entire online marketplace.
